(19) United States
(12) Patent Application Publication
(10) Pub. No.: US 2016/0110957 A1
(43) Pub. Date: Apr. 21, 2016

(54) IN GAME DELIVERY OF DIGITAL PERSONALIZED OFFERS

(71) Applicant: Aintu Inc., San Jose, CA (US)

(72) Inventor: Arthur Vaysman, San Jose, CA (US)

(21) Appl. No.: 14/884,756

(22) Filed: Oct. 15, 2015

Related U.S. Application Data
(60) Provisional application No. 62/064,222, filed on Oct. 15, 2014.

(51) Int. Cl. G07F 17/32

(52) U.S. Cl. CPC G07F 17/3255; G07F 17/3262

(57) ABSTRACT

A method for generating content for a game is disclosed. The method comprises monitoring game play associated with a gamer playing a video game; provisioning at least one trigger, which if met, triggers the generation of a transaction-enabled offer, wherein said at least one trigger is associated with said game play; for each trigger that is met, customizing that transaction-enabled offer for said gamer; and transmitting said transaction-enabled offer to a game console associated with said video game for dynamic insertion into a user interface of the video game.

### FIELD

Embodiments of the invention relate to the delivery of content in in general, and the delivery of electronic content in particular.

### BACKGROUND

Video games are extremely popular, and it is not uncommon for gamers to spend a significant amount of time with their attention focused on a display screen associated with a video game.

### SUMMARY

According to one aspect of the invention, there is provided a method for delivering real time in-game content to a video game console. In one deployment scenario a video game console is configured to monitor certain aspects of game play and to report on said aspects to a server application. The server application may be provisioned with a content placement engine configured to deliver a real time digital personalized offer to a user of the video game console.

Advantageously, a size or value of the personalize offer may be commensurate with a level of proficiency of a gamer/user.

The personalized offer may include a discount on the purchase price of a product or service. Advantageously, the product or service may be highly relevant or targeted to the gamer, without the gamer having to provide information explicitly to facilitate the personalization of offers. For example, the content placement engine may be configured to target the gamer based on interactions between the gamer and a coupon application.

In some embodiments, the personalized offer may comprise a reward to the gamer for reaching a certain proficiency level in playing the game. The proficiency level may be measured in terms of a gamer's own increases in skill in playing a game. Alternatively, the proficiency level may be measured across multiple users.

The personalized offer may comprise anything of value to the gamer and may include, for example, virtual goods.

Advantageously, the personalized offers disclosed herein are designed so as to blend with other video game content, so as to be aesthetically pleasing and non-intrusive to a gamer. Moreover, the personalized offers may be “clipped” by a gamer with a simple single operation, for example click or touch, to remove the personalized offer from view so that game play may continue without any distraction. The clipped personalized offer may be seamlessly added to a coupon application for later use by the gamer.

According, to another aspect of the invention, an offer bidding engine may be configured to enable bidding between advertisers for the placement of in-game digital personalized offers.

Other aspects of the invention will be apparent from the detailed description below.

### BRIEF DESCRIPTION OF THE DRAWINGS

FIG. 1 shows a deployment drawing in accordance with one embodiment of the invention

FIG. 2 shows the use cases for the DCPMS, in accordance with one embodiment of the invention.

FIG. 3 shows the use cases for coupon generation, in accordance with one embodiment of the invention.

FIG. 4 shows the use cases for coupon clipping and publishing in accordance with one embodiment of the invention.

FIG. 5 shows a coupon query Q1, in accordance with one embodiment of the invention.

FIG. 6 shows the use cases for the customer coupon app, in accordance with one embodiment of the invention.

FIGS. 7a-b shows a Publisher publishing media on a Customer node, in accordance with one embodiment of the invention.

FIG. 8 shows a flowchart for processing a coupon clipping notification, in accordance with one embodiment of the invention.

FIG. 9A shows the use cases for coupon redemption by the customer coupon app, in accordance with one embodiment of the invention.

FIG. 9B shows the use cases for coupon redemption by the retailer coupon app, in accordance with one embodiment of the invention.

FIG. 10 shows an example of published coupon, in accordance with one embodiment of the invention.

FIG. 11 shows the published coupon of FIG. 10 in magnified view, in accordance with one embodiment of the invention.

FIG. 12 shows an example of a report to an Advertiser, in accordance with one embodiment of the invention.

FIG. 13

FIG. 14 shows a deployment scenario for video game placement, in accordance with embodiment of the invention.

FIG. 15 shows a game user interface.

FIG. 16 illustrates the elements of a video game.

FIG. 17 list is a transmission of content from a video game console two the video game content placement system, in accordance with one embodiment of the invention.

FIGS. 18-19 show a flowchart of operations performed to process content from the video game console, in accordance with one embodiment of the invention.

FIG. 20 shows a flowchart of operations for a registration process, in accordance with one embodiment of the invention

FIG. 21 shows a flowchart of operations for a content personalization process, in accordance with one embodiment of the invention.

FIG. 22 shows a high-level block diagram of hardware for implementing the DCPMS, in accordance with one embodiment of the invention.

### DETAILED DESCRIPTION OF SOME EMBODIMENTS

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form only in order to avoid obscuring the invention.

Reference in this specification to “one embodiment” or “an embodiment” means that a particular feature, structure, or characteristic described in connection with the embodiment is included in at least one embodiment of the invention. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to said details are within the scope of the present invention. Similarly, although many of the features of the present invention are described in terms of each other, or in conjunction with each other, one skilled in the art will appreciate that many of these features can be provided independently of other features. Accordingly, this description of the invention is set forth without any loss of generality to, and without imposing limitations upon, the invention.

The technology disclosed herein relates to the creation and delivery of a digital personalized offer as in-game content associated with a video game. Advantageously, the personalized offer may be highly targeted to a gamer consumer based on information gathered about the customer by means of a coupon application. Thus, intelligence or learnings about a gamer's shopping behavior may be leveraged to deliver targeted content to the gamer as the gamer plays the game.

Broadly, elements of the invention comprise a coupon personalization system and a video game content placement system.

The Coupon Personalization System

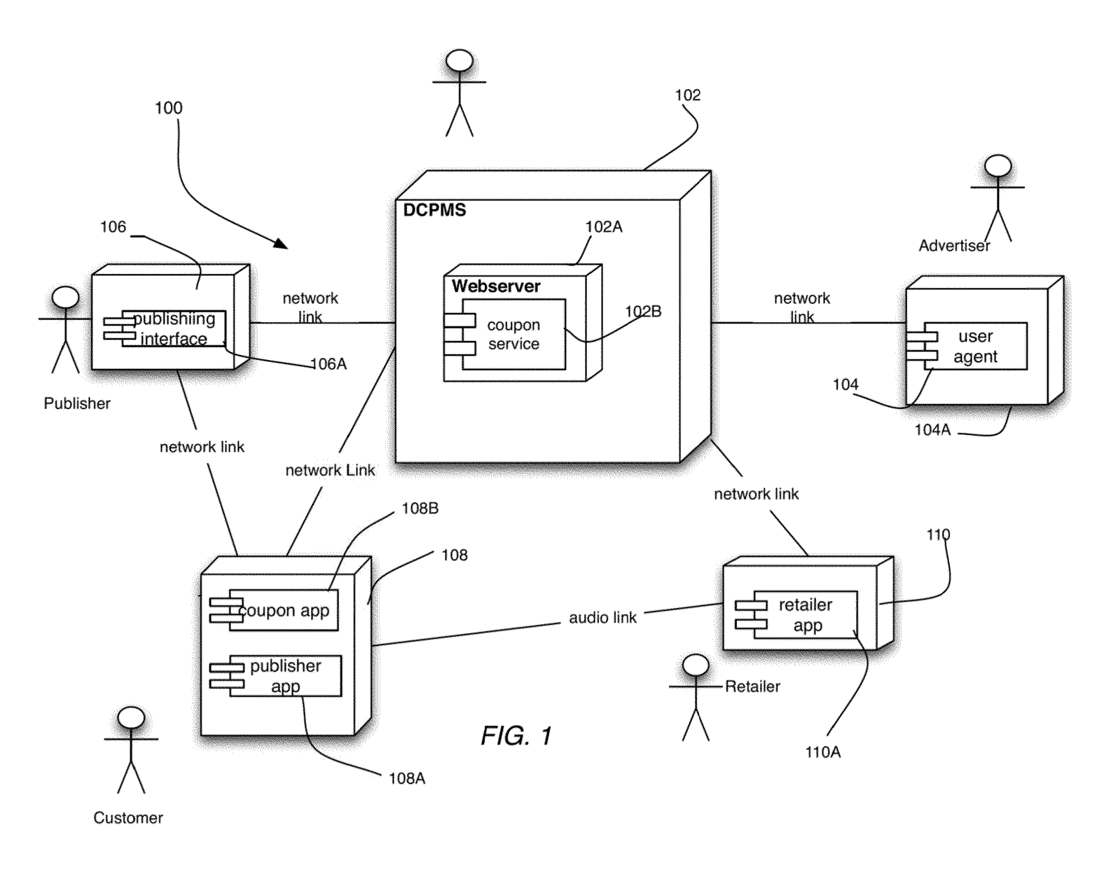

FIG. 1 shows a deployment scenario 100 for the coupon personalization system in accordance with one embodiment of the invention. Referring to FIG. 1 a Digital Coupon Personalization and Management System (DCPMS) 102 includes a server component 102A which implements a Coupon Service (CS) 102B. The CS 102B is under control of a Coupon Service Provider (CSP) A plurality of advertiser nodes 104 each equipped with an appropriate user agent (browser) 104A are communicatively coupled to the DCPMS 102 by means of a network link 112. In one embodiment, each advertiser node 104 may include a computing device such as a laptop or PC, and the network link 112 may comprise the Internet. Each advertiser node 104 represent an Advertiser who uses the CS to generate coupons on its behalf, as will be explained.

The DCPMS 102 may also be communicatively coupled with plurality of publisher nodes 106 by means of a network link 112. Each publisher node 106 represents a computing device such as a PC and includes a publishing interface 106A, which represent the mechanism whereby a Publisher is able to publish media on a customer node 108 for viewing by a Customer. Examples of Publishers includes CNN, Facebook, YouTube, etc.

The customer node 108 represents a customer device such as smartphone or tablet PC. In one embodiment, the customer node 108 may include a publisher app 108A and a coupon app 108B. The publisher app 108A may be configured to receive media content from a Publisher, as will be described more fully later. The media content may include a personalized coupon generated by the DCPMS 102.

Finally, the deployment scenario 100 also includes a retailer node 110 which represents retailer. In one embodiment, the customer node 108 communicates with the retailer node 110 via an audio link 114.

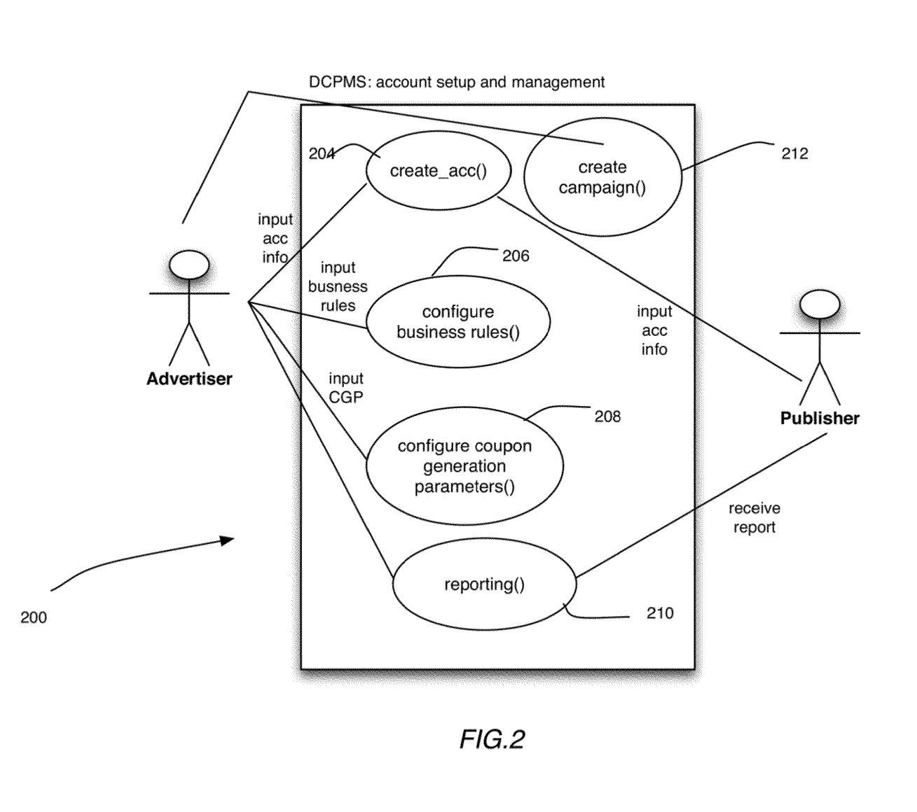

FIG. 2 shows use cases 200 for the DCPMS 102, in accordance with one embodiment of the invention. As will be seen, the DCPMS 102 supports α create_account ( ) function 202 which allows an Advertiser and a Publisher to create user accounts on the DCPMS 102. A configure_business_rules ( ) function 208 allows an Advertiser to provision business rules and objectives in the DCPMS 102. The business rules and objectives may be used to generate highly personalized coupons for publishing to particular customers, as will be described. The use cases 200 also includes a configure_coupon_generation_parameters( ) process 210 whereby an advertiser configures coupon generation parameters which are used to generate personalized coupons. Examples of coupon generation parameters include the following:
(a) Demographic data;
(b) Geographic data;
(c) Offer size for a coupon offer. This may be specified in the terms of a minimum offer size and a maximum offer size;
(d) The particular medium for which a coupon needs to be generated. Examples of media include video content, banner ads, and printed ads.
(e) Publisher, Examples of publishers includes Facebook, YouTube, CNN etc.;
(f) Context for the coupon. Examples of contexts includes sports, politics, science, business, lifestyle, etc.;
(g) Psycho-graphic information comprising values, opinions, attributes, interests, and lifestyles associated with a target demographic group.

Finally, the use cases 200 include a reporting ( ) function 212 whereby reports are generated for Advertisers and Publishers.

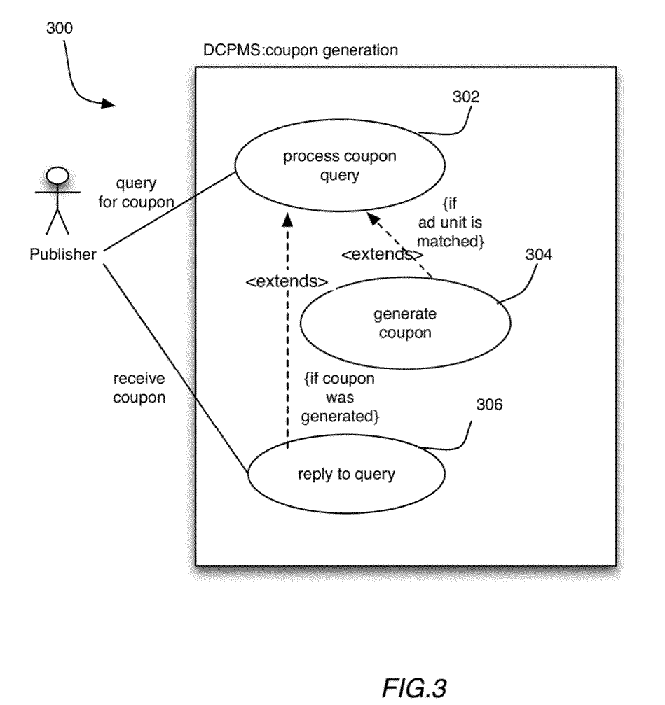

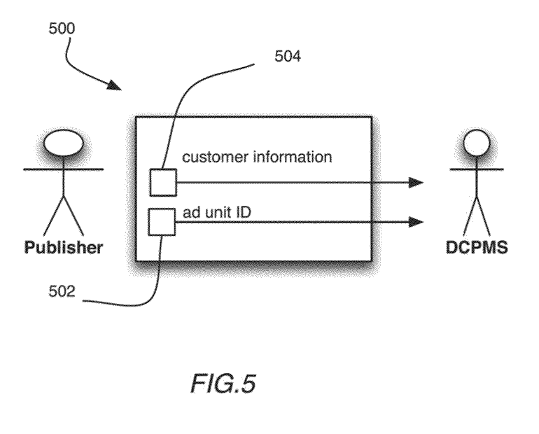

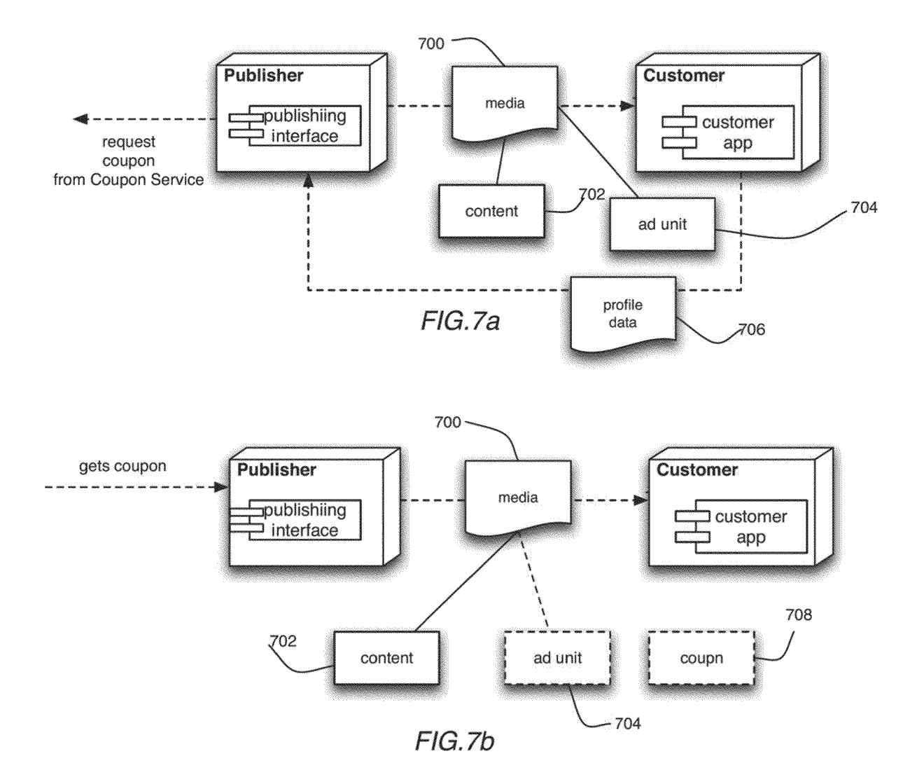

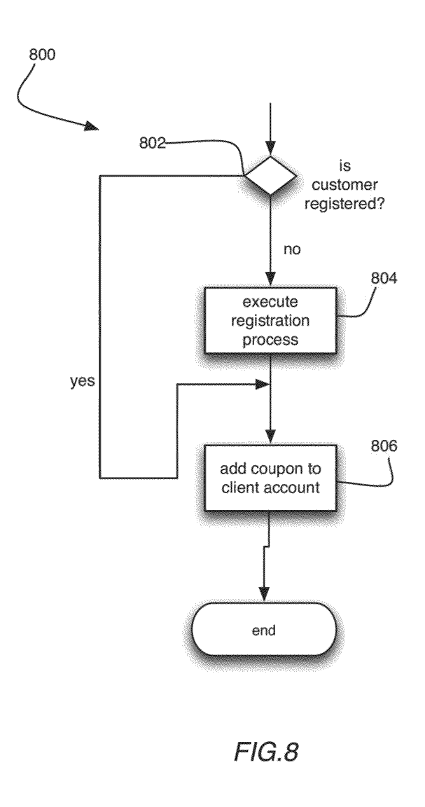

Referring now to FIG. 3 of the drawings, there is shown use cases 300 for coupon generation, in accordance with one embodiment of the invention. In terms of the use cases 300, a Publisher sends a query Q1 to the DCPMS 102. The query Q1 is a request for a coupon. Generally, at the time of sending the query Q1, the Publisher is already publishing content to a customer and is the further, typically displaying an advertisement unit (ad unit) in association with the content. This can be seen in FIG. 7a, which shows media 700 being published on a customer node 108, wherein the media 700 includes content 702 and an ad unit 704. FIG. 5 shows the elements of the query Q1, in one embodiment. As will be seen. Q1 includes customer information 500 and an ad unit id 502. The ad unit id 502 corresponds to the ad unit being shown to the Customer. The customer information corresponds to profile information/data 706 (see FIG. 8) about the Customer. The profile data 706 is collected from the Customer node 108 by the Publisher and includes that customer's browsing behavior and information about the customer device itself.

Responsive to receiving the coupon query Q1, the DCPMS 102 executes a process coupon query block 304. Under this block, the DCPMS 102 attempts to match the ad unit id in the coupon query Q1 in an ad unit list. The ad unit list is provisioned by an Advertiser and is basically a listing of ad units for which coupons must be generated by DCPMS 102. Thus, under the process 304, if the ad unit id is matched then a generate coupon function 306 is executed. Under this process, a personalized coupon is generated based on the coupon configuration parameters and based on machine learning techniques.

The use cases 300 also include a reply to query function 308 wherein the DCPMS 102 replies to the query Q1 by returning a coupon to the publisher 302 or a reply indicating that no coupon is available for the particular ad unit associated with the coupon request Q1. FIG. 7B shows the media 700 that is published on a customer node 108 as updated by the Publisher to include a coupon 708.

Controlling the Placement of a Coupon Within an ad Unit

In one embodiment, the reply to the coupon query Q1 may include information to control the placement of a coupon within the ad unit. Controlling the placement of a coupon within an ad unit is important so as not to obscure the content associated with the ad unit. For this embodiment, the DCPMS 102 maintains coupon placement information the specifies spatial placement information for each coupon associated with an ad unit (as identified by its ad unit id). Thus, once the ad unit id associated with a coupon query Q1 is matched, a coupon is generated and a reply to the coupon query Q1 is transmitted to the publisher, as has been described above with reference to FIG. 2. However, and additionally, a lookup of coupon placement information for the generated coupon may also be performed. The lookup is by ad unit id. If coupon placement information has been provisioned in the DCPMS 102 for the particular ad unit, the said coupon placement information is provided in the reply to query ( ) process 306 to the publisher. In some embodiments, the coupon placement information ma also include temporal placement information, which is useful for ad unit with video content. The coupon placement information may be specified in terms of coordinates associated with the ad unit that was matched. In some embodiments, the reply to query ( ) process 306 may be configured to send a coupon and its placement information directly to the customer coupon app 108B.

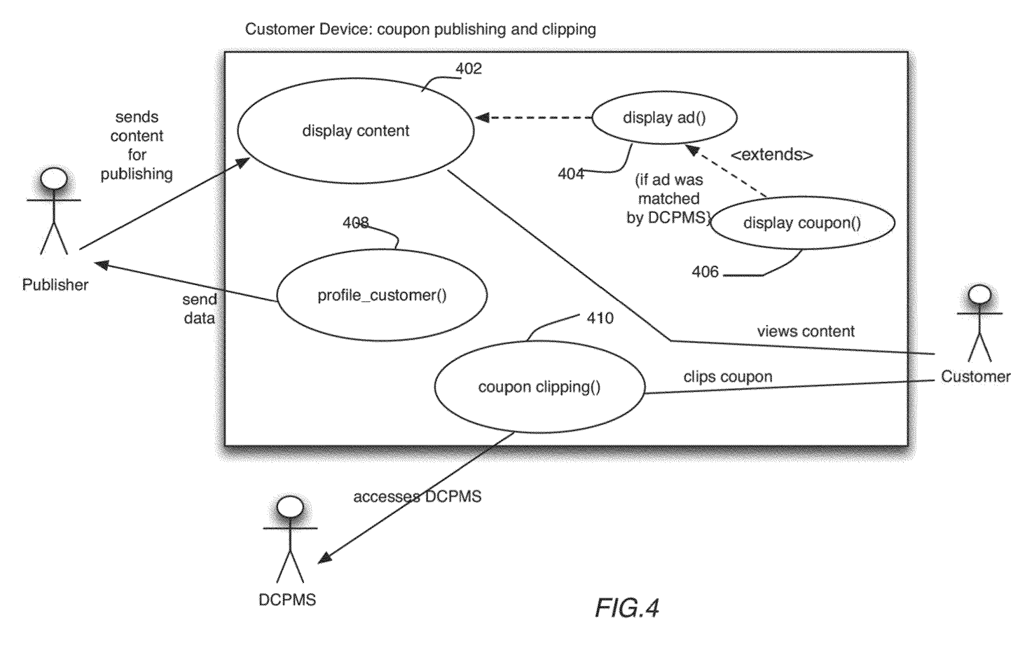

FIG. 4 shows use cases 400 for coupon displaying and clipping on the customer node 402, in accordance with one embodiment of the invention. As will be seen, the customer node 108 is configured to display content by executing a display content function 402. The display content function 402 may be extended to include a display ad function 404 which in turn may be extended to include a display coupon function 406 if the ad unit associated with the ad being displayed is match by the DCPMS 102, as described earlier. A profile customer ( ) function 408 collects profile information for a customer which is transmitted to the Publisher. The use cases 400 also includes a coupon clipping ( ) function 410. Under the coupon clipping function 410, a Customer performs a ‘clipping action’ in relation to a coupon. For example, in one embodiment, the clipping action may include selection of a clipping button associated with the coupon. Responsive to said clipping action, the coupon clipping, function 410 generates a coupon clipping notification and transmits it to the DCPMS 102.

Referring now to FIG. 8 of the drawings, there is shown a process 800 executed on the DCPMS 102 responsive to receiving a coupon clipping notification. At block 802, a check is made to determine if the customer is a registered customer. In one embodiment this step includes validating customer credentials included in the coupon clipping notification. If it is determined that the customer was not registered, then at block 804, a registration process is executed in order to register the customer. This process may include redirecting, a customer to a registration page in order for the customer to input registration information. At block 806, the coupon identified by the coupon id in the coupon clipping notification is added to the customer's account. At this point, the DCPMS 102 may inform the Publisher that the coupon has been clipped, in which case the publisher may instruct a browser being used by the customer node 108 to view the coupon to stop displaying the coupon.

In the case where a Customer is using the coupon app 108B to view the published content, the coupon app 108B includes logic to stop showing the coupon as soon as the coupon clipping action is performed. Thus, a seamless coupon clipping experience is facilitated.

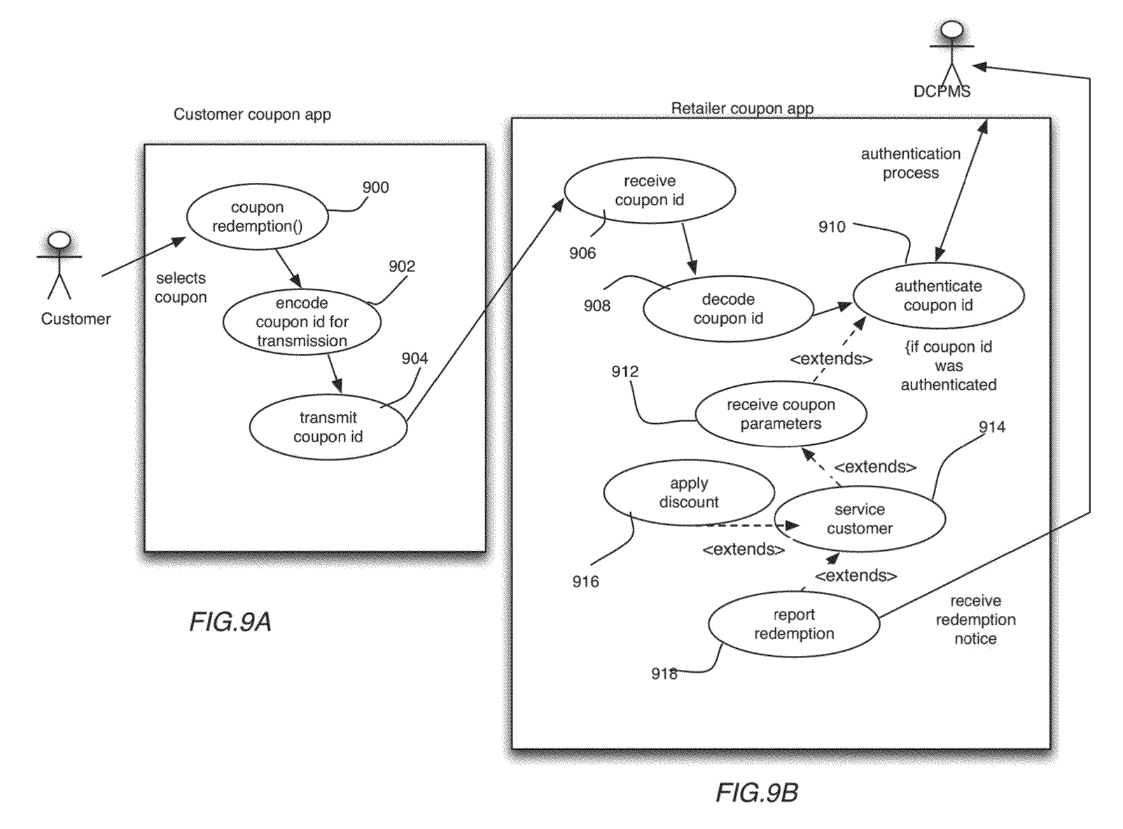

Referring now to FIG. 9A of the drawings, there is shown a use case for coupon redemption by a Customer. As will be seen, a coupon redemption( ) function 900 includes a process 902 for encoding a coupon for transmission, and a process 904 for transmitting said encoded coupon to a retailer node. In one embodiment, the process 902 for encoding the coupon for transmission encodes the coupon as an audio signal which is then transmitted via a speaker associated with the customer node 108. The retailer node 110 then uses a microphone to detect the audio encoding. FIG. 9B also shows a use case for the retailer coupon app 110A to redeem a coupon, in accordance with one embodiment. Referring to FIG. 9B, process 906 comprises a receive coupon id ( ) function whereby a microphone of the retailer node 110 is used to listen for the coupon transmission from the customer node 108. A decode coupon id ( ) process 908 decodes the audio signal in order to extract the coupon id. An authenticate coupon id ( ) process 910 includes transmission of the coupon id to the DCPMS 102 by the retailer coupon app for authentication. The DCPMS 102 authenticates the coupon id and returns coupon parameters associated with the coupon id that was authenticated. The retailer coupon app then executes a receive coupon parameters( ) function 912 to receive the coupon parameters from the DCPMS 102. A service customer ( ) function 914 includes servicing the customer by providing the goods and/or services associated with the coupon. A apply discount ( ) function 916 extends the service customer ( ) function 914 to apply the discount indicated in the coupon to the transaction with the customer. A report redemption ( ) function 918 includes operations to report any coupon redemption to the DCPMS 102.

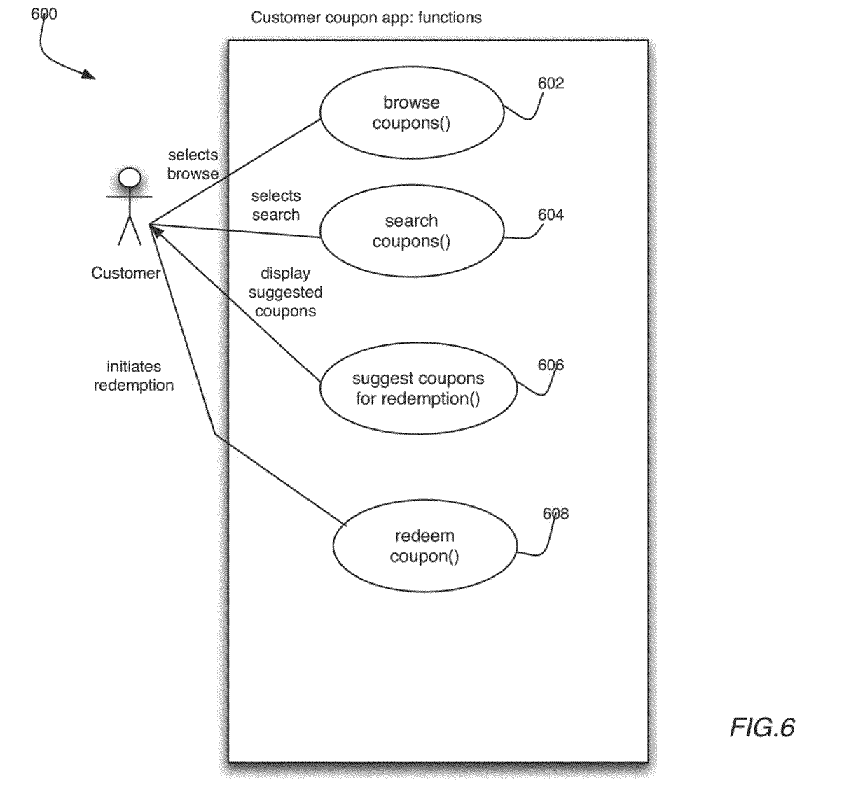

Referring now to FIG. 6 of the drawings, use cases 600 are associated with the coupon app 108B. As will be seen, the use cases 600 may include a browse coupons ( ) function 602. This function allows a Customer to browse previously clipped coupons. A search coupon ( ) function 604 allows the Customer to search for particular coupons based on search criteria. A suggest coupon for redemption ( ) function 608 implements functionality to proactively suggest coupons for redemption to a Customer. For example, in one embodiment based on the location, the Customer may be shown coupons that are only available for redemption at that particular location. Finally, the use case 600 includes a redeem coupon function ( ) 610, whereby the Customer may redeem a selected coupon, as has been described above.

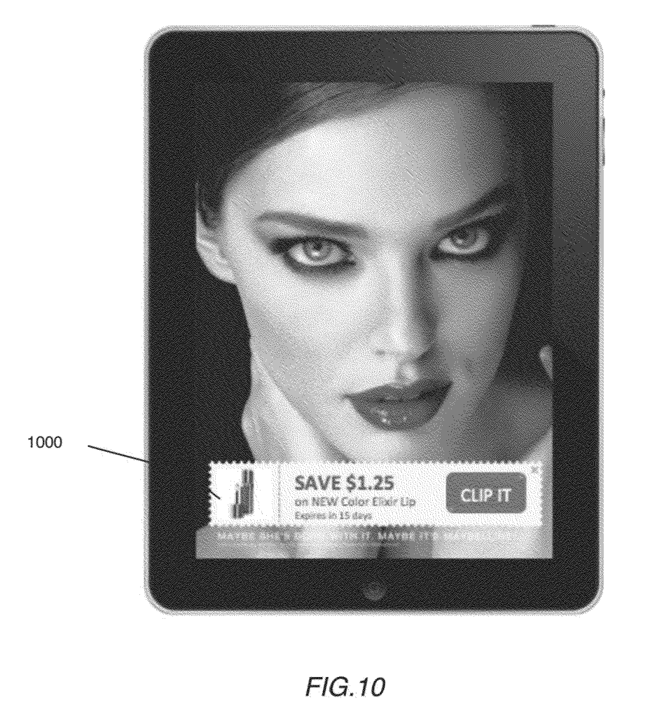

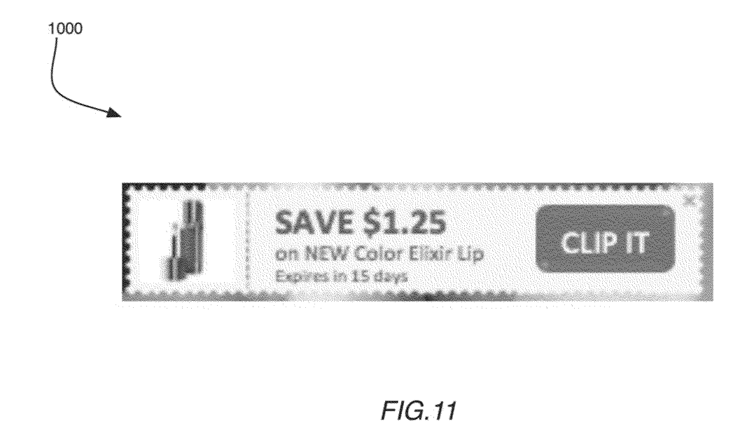

Referring now to FIG. 10 of the drawings, there is shown a coupon 1000 which is published in association with an advertisement for women ‘s’ lipstick. The coupon 1000 is shown in magnified view FIG. 11 of the drawings. As will be seen, the coupon 1000 includes a discount of $1.25, and a coupon expiration, which is set to 15 days. Further, the coupon 1000 includes a ‘clip it button’. This button may be used to clip the coupon 1000 in accordance with the techniques disclosed herein.

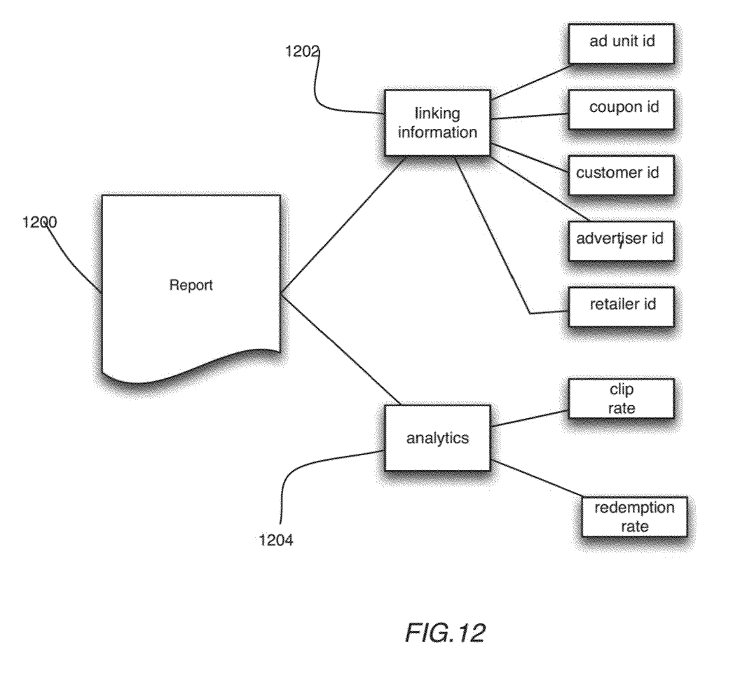

FIG. 12 shows a report 1200 that may be generated for an Advertiser, in accordance with one embodiment. The report 1200 includes linking information 1202 to link ad unit id, coupon id, customer id, advertiser id, and retailer id. Report 1200 also includes an analytics component 1204 which may provide detailed analysis on a coupon's clip rate and its redemption rate. The coupon clip rate and redemption rate may be used to optimize a coupon campaign. As has been mentioned, machine running techniques are used to generate a coupon in a dynamic fashion. For example, coupon may be configured to have a certain clip rate and a certain redemption. If a clip rate for a coupon is too high the system may dynamically reduce the discount associated with the coupon in order to throttle or scale back the redemption rate. Alternatively, if the coupon clip rate is too low, then the DCPM 102 may dynamically increase the discount associated with the coupon in order to achieve the desired clip rate. Likewise, a coupons redemptions rate may be used to dynamically scale the offer sized associated with the coupon in order to achieve a desirable redemption rate.

In some cases, a coupons face value may be overridden to a deeper discount in real time, if a customer is attempting to redeem the coupon based on a high volume purchase. For this case, the authenticate coupon id ( ) process 910 may includes transmission of the coupon id to the DCPMS 102 by the retailer coupon app for authentication as before and additionally, the number of items being purchased. The number of items being purchased allows the DCPMS 102 to dynamically modify the discount associated with a coupon based on the number of items being purchased.

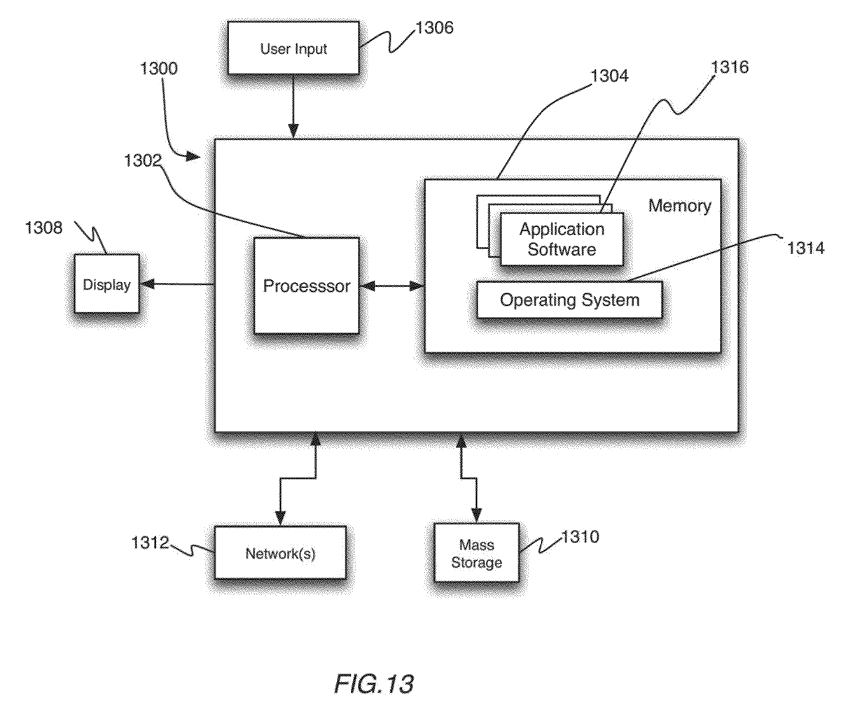

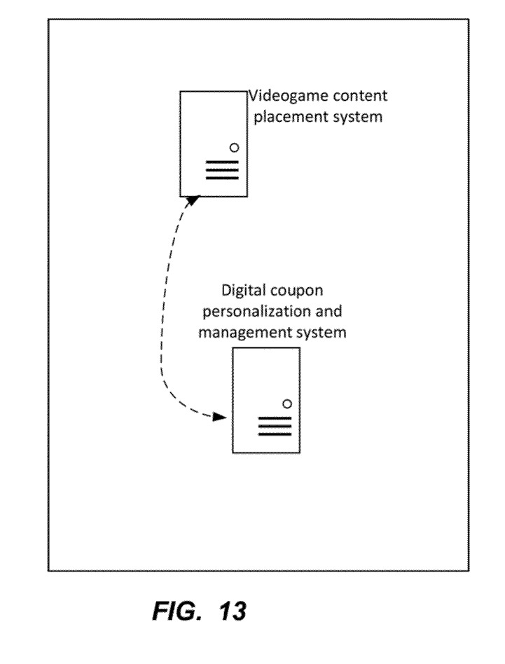

For purposes of the personalization of in-game offers, the DCPMS 102 may be regarded as comprising two separate systems in the form of a video game content placement system and a digital coupon personalization and management system, as illustrated in FIG. 13.

### The Video Game Content Placement System

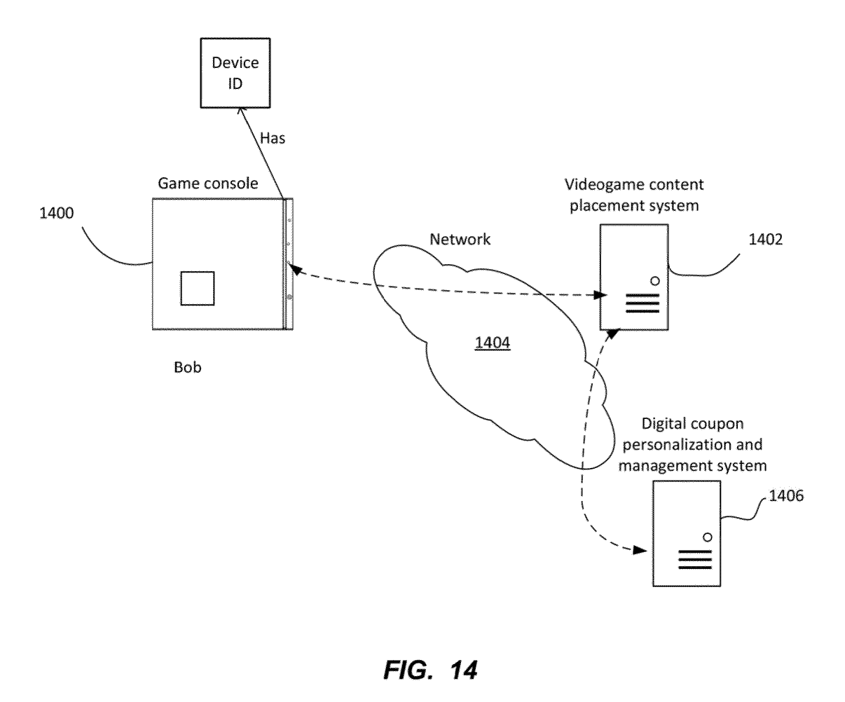

FIG. 14 shows a deployment scenario for video game content placement system, in accordance with one embodiment of the invention. Referring to FIG. 14, reference numeral 1400 indicates a video game console. It is to be understood that the term “video game console” is to be interpreted broadly to include traditional video game consoles such the PlayStation, and the Xbox as well as any other device on which a game may be played including devices such as smartphones. It is important to note that the console 1400 will include a device ID, as will be known to one of ordinary skill in the art. The game console 1400 is communicatively coupled to a video game placement system 1402. For this purpose, communications between a game console 1400 and a system 1402 are facilitated by a communications network 1404. The communications network 1404 may include any network capable of supporting wireless communications between the game console 1400 to the video game placement system 1402. As such, the network 1404 may include a combination of wired and wireless networks. For purposes of illustration, the network 1400 may be considered to comprise the Internet. It is to be understood that although only one game console 1400 is depicted, in reality a plurality of game consoles 1400 may be communicatively coupled to the video game placement system 1404.

The deployment scenario, also includes a DCPMS 1406 which is similar to the previously described DCPMS 102.

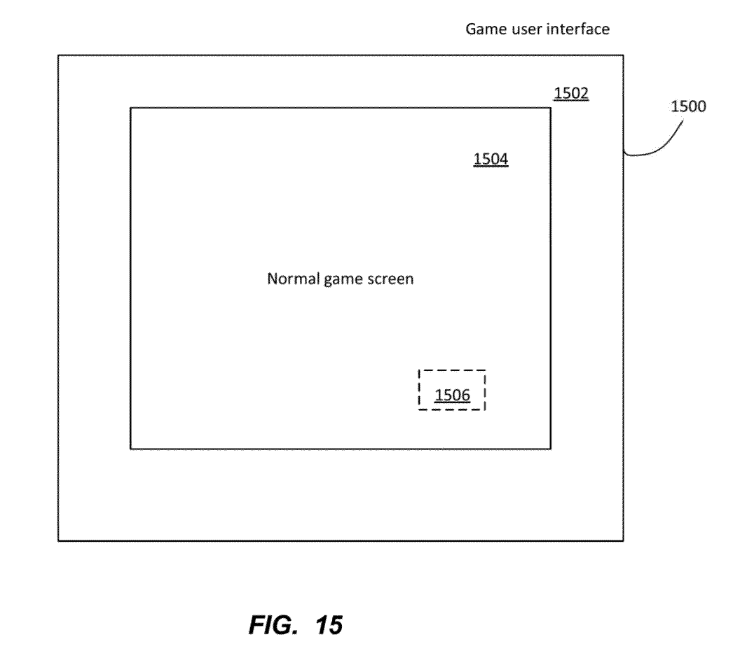

For ease of description, consider that a user Bob is playing a video game by means of the game console 1400. The game console 1400 is provisioned with placement application 1408. In one embodiment, the application 1408 is configured to collect metrics/statistics relating to the playing of video game by Bob. For example, the statistics may include how well Bob is playing based on Bob's score. In terms of other functionality, the application 1408 is very similar to the coupon app 108B. Referring now to FIG. 15 of the drawings, there is shown a game user interface 1500. As will be seen, the game user interface comprises a display 1502 within which is displayed a “normal game screen” 1504. The normal game screen 1504 generally comprises the visual elements of the video game without any content placement. Thus, ordinarily, the normal game screen with depict thematic and other elements of the game.

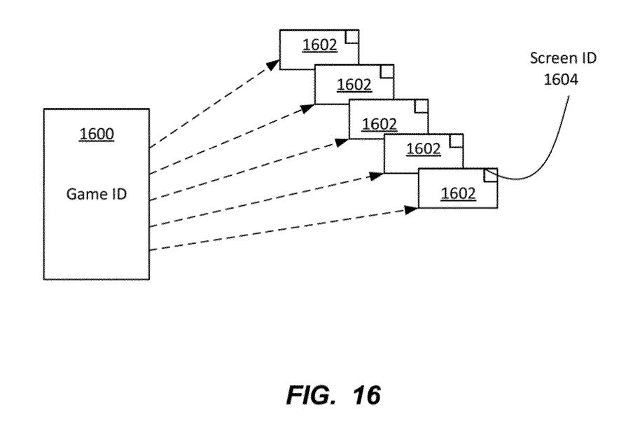

FIG. 16 indicates elements of a video game required for one embodiment of the present invention. Referring to FIG. 16, a game comprises a game ID 1600 and a plurality of game screens 1602. Each game screen includes a unique screen ID indicated by reference number 1604. The game ID uniquely identifies the video game.

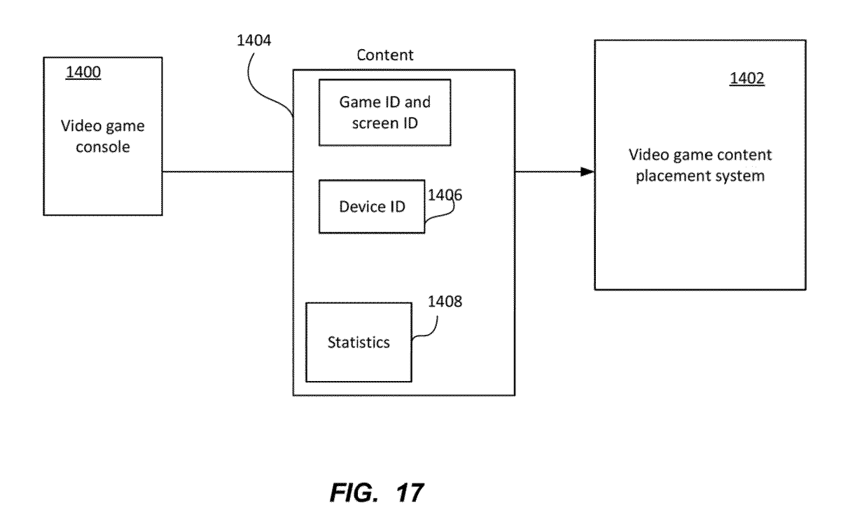

In one embodiment, the application 1408 may be configured to transmit information over the network 1404 to the video game placement system 1402. This is illustrated in FIG. 17 of the drawings. As will be seen, the information may include a content 1404. The content 1404 may include the game ID for the game currently being played and a screen ID for a screen currently active within the game. The content 1404 may also include a device ID 1406 associated with a video game console 1400 and statistics 1408. The statistics 1408 comprise information about Bob's game play. In particular, the statistics 1408 may include an indication of Bob's skill level or proficiency in playing the game. The skill level may be measured in terms of Bob's score within the game, in one embodiment.

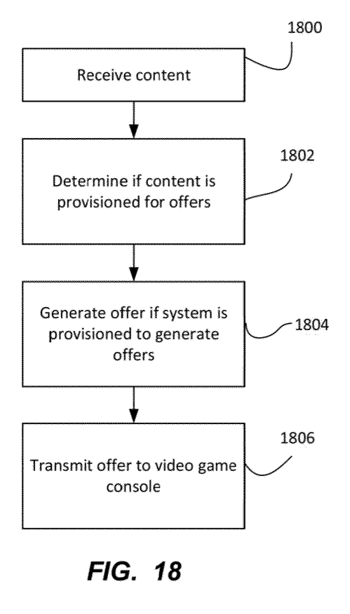

The information transmitted by the game console 1400 to the system 1402 is processed by said system in accordance with the flowchart of FIG. 18, in accordance with one embodiment. Referring to FIG. 18, at block 1800, the system 1402 receives the content transmitted by the game console 1400. As indicated, this content will include the game ID, the screen ID of the current screen, the device ID, and the statistics about game play.

At block 1802, the system 1402 determines if the video game identified by the video game ID has been provisioned for receiving offers. This step may be achieved by passing a combination of the game ID and the screen ID to the DCPMS 1406.

The DCPMS 1406 may be provisioned with offer generation parameters for advertisers. The offer generation parameters may be very similar to the coupon generation parameters described earlier.

If the video game has been provisioned to receive offers, then the DCPMS 1406 generates an offer. This step is indicated by the block 1804. The offer may comprise a coupon or advertisement for placement on a game screen of the video game. Initially the coupon may not be personalized to the user Bob.

The offer is then transmitted to the video game console, as indicated by the block 1806. The offer may be placed within the game screen in accordance with the placement techniques described earlier. For example, referring to FIG. 15 of the drawings, an offer 1506 is placed within the normal game screen 1504. In accordance with the techniques disclosed herein, the offer is non-intrusive in the sense that it is placed at a screen location selected to avoid obscuring important elements of the game screen. Moreover, visual elements of the offer may be selected to blend in with the visual elements of the game screen. Thus, from the point of view of the gamer, the offer seems to be native to the game itself.

The offer is configured so that it may be dipped to a coupon application of the user, in accordance with the techniques already described. For example, it also may be clipped by the user-action of selecting the offer by means of a game controller. Once selected, advantageously the offer disappears from view so that the gamer may resume normal gaming.

In accordance with one embodiment, clipping of an offer in the manner described will trigger a content transmission step which is very similar to what has already been described with reference to FIG. 17 of the drawings.

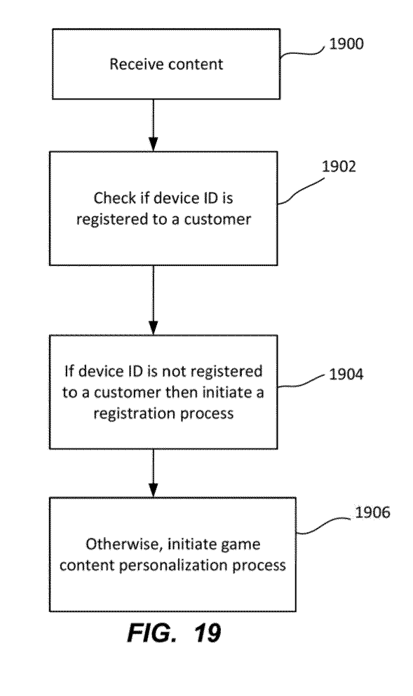

Referring to FIG. 19, at block 1900 the content transmitted by a game console is received by the placement system 1402. A check is then performed to determine if the device ID identified in the content is registered to a customer of the coupon service 102B. In one embodiment, to perform this step, the device ID is passed to the system 1406. The system 1406 may be configured to implement the coupon service 102B and to store customer profiles for all customers of the coupon service. An attribute of each customer profile will include device ID of each device associated with the customer. Thus, given a device ID, the system 1406 will be able to determine if there is a customer ID associated with said device ID.

If the device ID is not registered to a customer, then at block 1904 a registration process is initiated. The registration process is to register the gamer for the coupon service. If it is determined that the gamer is indeed a registered with the coupon service, then at block 1906 a content personalization process is initiated.

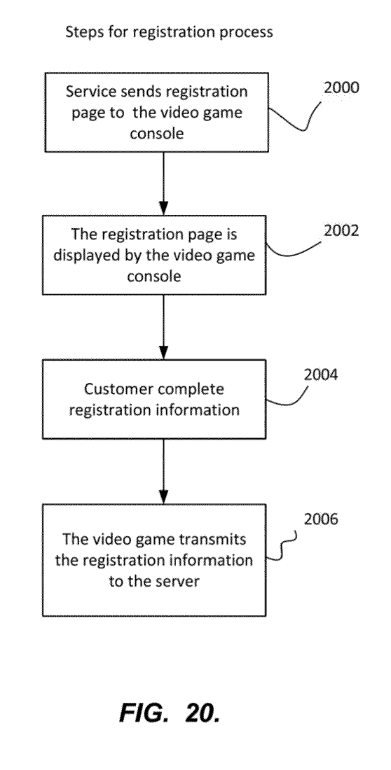

The steps for the registration process are illustrated in FIG. 20, in accordance with one embodiment of the invention. Referring to FIG. 20, at block 2000 the DCPMS 1406 generates a registration page which is sent to the video game console by the system 1402. The registration page includes fields for data entry for the required in order to register a user for the coupon service. At block 2002, the video game console displays the registration page. At block 2004, the customer completes the required fields, and at block 2006, the video game console transmits the registration information to the system 1402. The system 1402, in turn passes the registration information to the DCPMS 1406 which then registers the user. Thus, the user becomes a user of the coupon service. The user downloads the customer coupon app 108B and by clipping coupons as described above a rich profile is built of the customers’ shopping habits, and likes and dislikes, information contained in this profile, is advantageously used in the personalization offers for the gamer during game play.

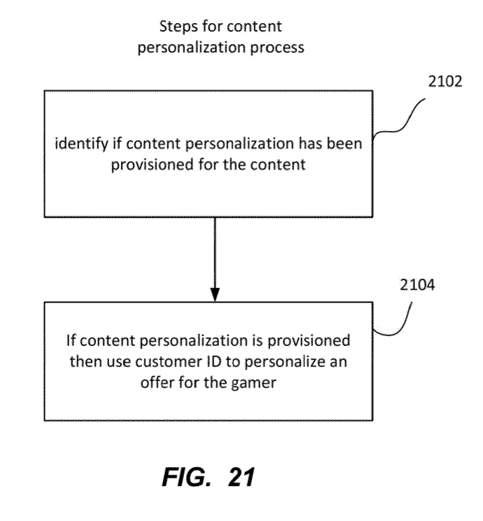

FIG. 21 of the drawings illustrates the steps for the personalization of coupons/offers, in accordance with one embodiment. Referring to FIG. 21, at block 2102 the content ID is used to determine if content personalization has been provisioned for the content associated with the content ID. The step of the provisioning personalization for content may include a bidding process in terms of which multiple vendors/advertisers may bid for the right to place personalized offers one within games.

If the content identified by the content ID is provisioned for personalization, then the customer profile for the customer identified by the device ID within the coupon service is used to drive the personalization of the offer in accordance with the techniques already described. For example, one aspect of personalization may include customization of a size of scale of an offer based on a user's in-game performance. For example, if a user is determined to be proficient in playing a game, the user may be rewarded with an offer who sizes based on the user's level of skill. In a simpler case, users who have low games scores may receive lower offers, then uses who have higher game scores.

In some cases, users may actively compete against each other for offers/rewards. For example, all games currently playing the same video game may be placed into a pool, and the performance of the garners are tracked. Offers may then be generated as a reward for the top performers in the pool.

The in-game offers their personalized and delivered to a video game consoles in accordance with the techniques disclosed herein are referred to as being transaction-enabled. This means that upon the user-action of clipping, any provisioned transaction/action may be taken. For example, the transaction may be the shipping of samples to the consumer, or an offer of a discount for product or service.

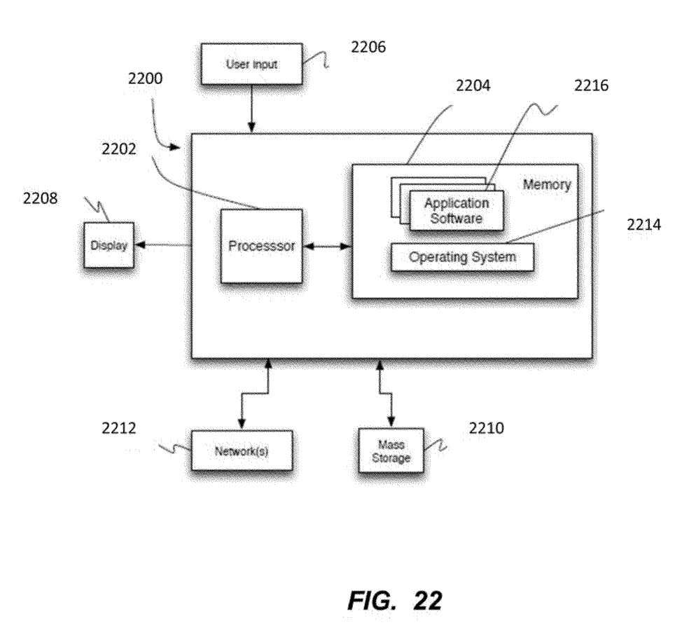

FIG. 22 shows an example of hardware 2200 that may be used to implement the DCPMS 102 in accordance with one embodiment. The hardware 2200 may include at least one processor 2202 coupled to a memory 2204. The processor 2202 may represent one or more processors (e.g., Microprocessors), and the Memory 2204 may represent random access memory (RAM) devices comprising a main storage of the hardware, as well as any supplemental levels of memory e.g., cache memories, non-volatile or back-up memories (e.g. programmable or flash memories), read-only memories, etc. In addition, the memory 2204 may be considered to include memory storage physically located elsewhere in the hardware, e.g. any cache memory in the processor 2202, as well as any storage capacity used as a virtual memory, e.g., as stored on a mass storage device.

The hardware also typically receives a number of inputs and outputs for communicating information externally. For interface with a user or operator, the hardware may include one or more user input output devices 2206 (e.g., a keyboard, mouse, etc.) and a display 2208. For additional storage, the hardware 2200 may also include one or more mass storage devices 410, e.g., a Universal Serial Bus (USB) or other removable disk drive, a hard disk drive, a Direct Access Storage Device (DASD), an optical drive (e.g. a Compact Disk (CD) drive, a Digital Versatile Disk (DVD) drive, etc.) and/or a USB drive, among others. Furthermore, the hardware may include an interface with one or more networks 2212 (e.g., a local area network (LAN), a wide area network (WAN), a wireless network, and/or the Internet among others) to permit the communication of information with other computers coupled to the networks. It should be appreciated that the hardware typically includes suitable analog and/or digital interfaces between the processor 2212 and each of the components, as is well known in the art.

The hardware 2200 operates under the control of an operating system 2214, and executes application software 2216 which includes various computer software applications, components, programs, objects, modules, etc. to perform the techniques described above.

In general, the routines executed to implement the embodiments of the invention, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of machine or computer-readable media used to actually effect the distribution. Examples of computer-readable media include but are not limited to recordable type media such as volatile and non-volatile memory devices, USB and other removable media, hard disk drives, optical disks (e.g., Compact Disk Read-Only Memory (CD ROMS), Digital Versatile Disks, (DVDs), etc.), flash drives among others.

1. A method for generating content for a game, comprising:
monitoring game play associated with a gamer playing a video game;
provisioning at least one trigger, which if met, triggers the generation of a transaction-enabled offer, wherein said at least one trigger is associated with said game play:
for each trigger that is met, customizing that transaction-enabled offer for said gamer; and transmitting said transaction-enabled offer to a game console associated with said video game for dynamic insertion into a user interface of the video game.

2. The method of claim 1, the at least one trigger comprises a pre-defined level of proficiency reached by the gamer during game play.

3. The method of claim 1, wherein the at least one trigger comprises a pre-defined game context of the video game.

4. The method of claim 2, wherein the transaction-enabled offer comprises at least one reward for the gamer.

5. The method of claim 4, wherein a value associated with said reward is selected to be commensurate with the proficiency of the gamer.

6. The method of claim 5, wherein said award is selected from the group consisting of discounts, redeemable points, and virtual goods.

7. The method of claim 1, wherein customizing the transaction-enabled offer comprises selecting the offer based on a user-profile for the gamer which is passively built by monitoring shopping-related activities associated with the gamer.

8. The system, comprising:
a processor; and
a memory coupled to the processor, the memory storing instructions which when executed by the processor, causes the system to perform a method for generating content for a game, said method comprising:
monitoring game play associated with a gamer playing a video game;
provisioning at least one trigger, which if met, triggers the generation of a transaction-enabled offer, wherein said at least one trigger is associated with said game play; and
for each trigger that is met, customizing that transaction-enabled offer for said gamer; and transmitting, said transaction-enabled offer to a game console associated with said video game for dynamic insertion into a user interface of the video game.

9. The system of claim 8, wherein the at least one trigger comprises a pre-defined level of proficiency reached by the gamer during game play.

10. The system of claim 8, wherein the at least one trigger comprises a pre-defined game context of the video game.

11. The system of claim 8, wherein the transaction-enabled offer comprises at least one reward for the gamer.

12. The system of claim 11, wherein a value associated with said reward is selected to be commensurate with the proficiency of the gamer.

13. The system of claim 12, wherein said award is selected from the group consisting of discounts, redeemable points, and virtual goods.

14. The system up up up up up up of claim 14, wherein customizing the transaction-enabled offer comprises selecting the offer based on a user-profile for the gamer which is passively built by monitoring shopping-related activities associated with the gamer.
